(19) United States
(12) Patent Application Publication
(10) Pub. No.: US 2002/0116956 A1
(43) Pub. Date: Aug. 29, 2002

(54) Method for producing quartz glass preform for optical fibers

(76) Inventors: Yasushi Fukunaga, Chiba-shi (JP); Masanori Suzuki, Koriyama-shi (JP)

Correspondence Address: LAW OFFICE OF ANDREW L. TIAJOLOFF, C/O ROBIN BLECKER & DALEY, 330 MADISON AVENUE, NEW YORK, NY, 10017, US

(21) Appl. No.: 10/066,413

(22) Filed: Jan. 31, 2002

(30) Foreign Application Priority Data
Feb. 1, 2001 (JP) 2001-25163

(51) Int. Cl. C03B 37/027

(52) U.S. Cl. 65/435

(57) ABSTRACT

A method for producing a large quartz glass preform for optical fibers having a low ellipticity at a low cost is provided. The method comprises a heating and stretching of a large quartz glass cylinder or a preform in which a core rod is inserted in said quartz glass cylinder without being integrated with the cylinder in non-contact state, using a heating furnace equipped with a carbon-made heating element, whereby setting the ratio (d/D) of the outer diameter (D) of the large quartz glass cylinder and the inner diameter (d) of the heating element to a range of from 1.02 to 1.5, and blowing in an inert gas from the upper part of the heating furnace (FIG. 1)

### INDUSTRIAL FIELD OF APPLICATION

The present invention relates to a method for producing a quartz glass preform for optical fibers by heating and stretching a quartz glass cylinder having an outer diameter (D) using a heating furnace having an upper part and a lower part and being equipped with a carbon-made heating element with an inner diameter (d).

### PRIOR ART

Recently, in the field of a light communication, a large amount of optical fibers have been used, and to enlarge the using field of optical fibers, the increase of the mass production and lowering the cost thereof are inevitable. For the purpose, it is the simplest method to prepare a large high-precision quartz glass preform for optical fibers, for example, prepare a large preform for optical fibers by a rod-in-tube method, etc., and stretching and wire drawing the preform. Hitherto, for producing a quartz glass preform for optical fibers, a large cylinder is melt-softened by a stretching apparatus as shown in FIG. 3 and the quartz glass preform has been produced by stretching the softened cylinder to a tube. However, the ellipticity of the tube obtained is large and thus optical fibers having a high quality cannot be produced.

Thus, in Japanese Patent No. 3017491, it was intended to obtain a tube having a small ellipticity by maintaining a definite relation of the length and the inner diameter of a cylindrical heating element, which is equipped to a heating furnace and the outer diameter of a quartz glass preform, and stretching the preform in non-contact state. However, in the heating furnace described in the above-described patent, a temperature gradient occurs in the inside of the heating element to generate an ascending air current, the lower region of the heating furnace becomes a negative pressure, outside air of the furnace is sucked in, the inside wall of the carbon-made heating element is corroded by oxidation, whereby the heating element is severely consumed and also the dust generated by the corrosion attaches to the cylinder to make the temperature of the peripheral direction partially ununiform, the viscosity of the softened portion of the cylinder becomes abnormal, and only a tube having a large ellipticity is produced. Accordingly, as shown, for example, in Japanese Patent Laid-Open No. 95537/2000, a system of blowing in an inert gas from the upper portion of a heating element, whereby the generation of an ascending air current in a heating furnace is restrained and sucking in of air and the generation of an ununiform portion of temperature are prevented is proposed. However, even by stretching a large cylinder using the heating furnace, it is difficult to prepare a large quarts glass preform for optical fibers having a small ellipticity, as well as there is a restriction on the outer diameter of a quartz glass cylinder and it is difficult to produce optical fibers of a high quality at a low cost.

Problems that the Invention is to Solve

The object of the invention is to provide a method for producing a large quartz glass preform for optical fibers having a small ellipticity at a low cost.

Means for Solving the Problems

It has been found that the ellipticity of a quartz glass preform for optical fibers is largely influenced by an inert gas sucked in the heating furnace. Further investigations has shown that by setting the ratio of the outer diameter (D) of a quartz glass cylinder and the inner diameter (d) of the heating element of the heating furnace to a specific range, a large quartz glass preform for optical fibers having a small ellipticity can be produced and the present invention has been accomplished. That is, by setting the ratio (d/D) to the range of from 1.02 to 1.5, and blowing in an inert gas from the upper part of the heating furnace into the heating element.

Especially the present invention attaining the above-described object is a method for producing a quartz glass preform for optical fibers by stretching in non-contact state a large quartz glass cylinder using a heating furnace equipped with a carbon-made heating element, characterized by setting the ratio (d/D) of the outer diameter (D) of the large quartz glass cylinder and the inner diameter (d) of the heating element to the range of from 1.02 to 1.5, and blowing in an inert gas from the upper part of the heating furnace.

The above-described large quartz glass cylinder is produced by vaporizing silicon tetrachloride with high purity, flame hydrolyzing in an oxyhydrogen flame, accumulating the silica glass fine particles formed around a substrate to prepare a porous soot material, forming a transparent glass in an electric furnace at a temperature of from 1400 to 2000° C. to prepare a quartz glass ingot, grinding the outer diameter, forming a hole with a good precision by a core drill hole-opening apparatus in conformity with the circular center of the outer diameter, and then, if necessary, carrying out a mechanical polishing, an etching treatment with hydrofluoric acid, a water-washing treatment with pure water, etc.

Also, it is preferred that the outer diameter (D) is at least 190 mm. When the outer diameter is shorter than 190 mm, a quartz glass preform for optical fibers having a large ellipticity is formed. By using such a large quartz glass cylinder, the preparation of a quartz glass preform for optical fibers having a small ellipticity becomes easy, and optical fibers having a good quality can be produced with a good productivity and at a low cost. The above-described quartz glass preform for optical fibers are a tube used for the preparation of a preform for optical fibers or a preform wherein a core red is inserted in the inside of the quartz glass tube without being integrated with the tube.

As a heating furnace for melt-softening the above-described large quartz glass cylinder or a preform in which a core rod is inserted in said quartz glass cylinder, the heating furnace of a type of blowing in an inert gas from the upper portion of the heating furnace as shown in FIG. 1 is preferred. By blowing in an inert gas, a negative pressure generated in the lower portion of the heating furnace is prevented, whereby the occurrence of the corrosion by oxidation of the heating element by sucking in air outside the furnace can be reduced, and the ununiform temperature difference of the peripheral surface of the quartz glass cylinder caused by the generation of dust does not occur. Particularly, in a vertical resistance furnace and an induction furnace, stretching of a large quartz glass cylinder is easy, and the furnaces can be suitably used. The above-described resistance furnace is a furnace of heating by passing an electric current to a heating element being called heater to generate heat and in many cases, a cylindrical heater is used. Also, an induction furnace is a furnace in which by passing a high-frequency electric current, etc., near a heating element being called heater, an induction electric current is generated, whereby the heater generates heat, and in many cases, a cylindrical heater is used. As the inert gas used, a nitrogen gas, an argon gas, etc., is used.

It is preferred that the ratio (d/D) of the inner diameter (d) of the heating element of the heating furnace and the quartz glass cylinder (D) is set to the range of from 1.02 to 1.5, and preferably from 1.1 to 1.3, whereby the clearance of the inside surface of the heating element and the outside surface of the large quartz glass cylinder is established to be from 15 to 25 mm. When the above-described ratio (d/D) is less than 1.02, non-contact heating cannot be carried out and impurities of the heating element enter the inside of the quartz glass preform for optical fibers to stain the optical fibers. Also, when d/D exceeds 1.5, the difference in the concentration of the inert gas occurs and the large quarts glass cylinder or the preform in which the core rod is inserted in said quartz glass cylinder is ununiformly heated to increase the ellipticity.

At stretching described above, it is preferred to flow the inert gas through the inside of the quartz glass cylinder, and in this case, it is preferred to set the ratio (D/ID) of the outer diameter (D) to the inner diameter (ID) of the quartz glass cylinder to from 2 to 5. In stretching exceeding the above-described range, the quartz glass preform for optical fibers having a small ellipticity cannot be prepared.

A preferred modification of the method comprises a stretching and heating of a large quartz glass cylinder which is a hollow cylinder comprising a core rod which is co-axially inserted in said hollow cylinder without being integrated with it. In those case the ratio (D′/ID′) of the outer diameter (D′) to the inner diameter (ID′) of the hollow cylinder is set to <2 to 5. In stretching exceeding the above-described range, the quartz glass preform for optical fibers having a small ellipticity cannot be prepared.

### BRIEF DESCRIPTION OF THE DRAWINGS

FIG. 1 is a schematic cross sectional view of a vertical heating furnace for producing a quartz glass preform for optical fibers.

FIG. 2 is a graph showing the relation between the ellipticity and the ratio of the inner diameter of the heating furnace and the outer diameter of the quartz glass cylinder.

FIG. 3 is a schematic cross sectional view of a vertical heating furnace of prior art for producing quartz glass preform for optical fibers.

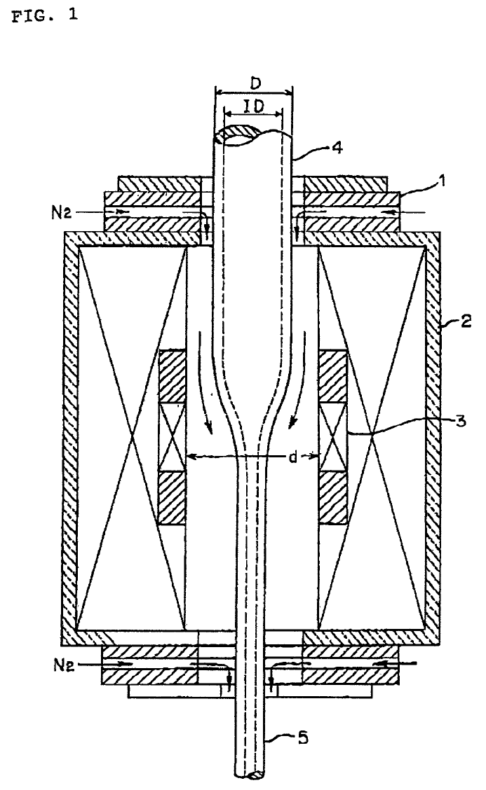

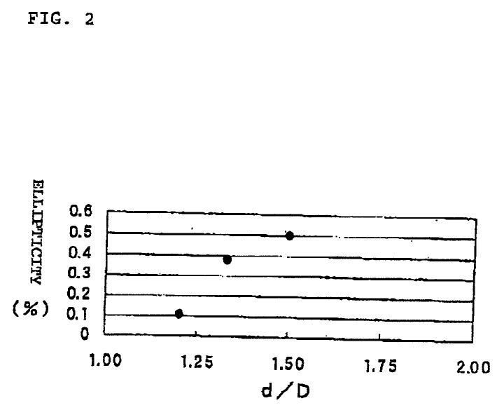

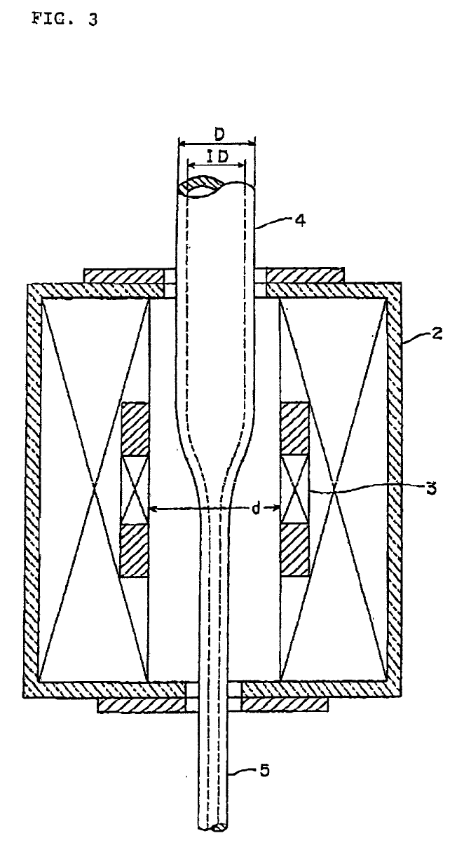

As one embodiment of the production method of the invention, a schematic cross-sectional view of the production method of the quartz glass preform for optical fibers using a vertical heating furnace is shown in FIG. 1. In FIG. 1, numeral 1 shows an inert gas supplying apparatus, 2 a heating furnace, 3 a heating element, 4 a cylinder, 5 is a tube, d the inner diameter of the heating furnace, D the outer diameter of the quartz glass cylinder, and ID the inner diameter of the quartz glass cylinder. The rate of change of the ellipticity in the case of changing d/D at stretching using the above-described heating furnace is shown in FIG. 2. The ellipticity is obtained as follows. That is, the quartz glass preform for optical fibers is rotated to the circumference direction, the outer diameters of the cross-sections are continuously measured, the maximum value and the minimum value are obtained, (the maximum value - the minimum value) is shown by OV (mm), and the ellipticity (%) is calculated by the following formula (1).

Ellipticity (%)=[OV(mm)/OD(mm)]×100 (1)

OD=outer diameter of the quartz glass preform for optical fibers

OV=maximum value minus minimum value

The outer diameters of the tubes produced by the production method of the invention are various, and OVs cannot be compared as they are, but by using the above-described formula 1, the ellipticity can be obtained regardless of the outer diameter of the quartz glass preforms for optical fibers.

### MODE FOR CARRYING OUT THE INVENTION

Then, the example of the invention is described below but the invention is not limited to the example.

### EXAMPLE 1

From a large porous soot material prepared by a VAD method of flame hydrolyzing evaporated silicon tetrachloride in an oxyhydrogen flame, a transparent glass was formed at 1600° C. to produce a quartz glass ingot. The outer diameter of the cylindrical quartz glass ingot was ground, then the dimension thereof was measured by a laser outer diameter measuring apparatus to obtain the circular center of the outer diameter, a hole was opened by a core drill hole opening apparatus in conformity with the circular center of the outer diameter, and etching treatment with hydrofluoric acid, water-washing with pure water, and drying were carried out to obtain a quartz glass cylinder having a length of 3500 mm, an outer diameter (D) of 200 mm, and an inner diameter (ID) of 50 mm.

The above-described quartz glass cylinder was set in the vertical resistance heating furnace having a carbon-made heating element of an outer diameter of 260 mm, an inner diameter (d) of 240 mm, and a length of 290 mm shown in FIG. 1, the temperature of the cylindrical heater was established to 2100° C., the quartz glass cylinder was stretched to a tube of an outer diameter (D′) of 90 mm. The OV of the tube obtained was 0.1 mm and according to the formula 1, the ellipticity became (0.1/90)×100=0.11%. In this case, the ratio (d/D) of the outer diameter of the quartz glass cylinder and the inner diameter of the heating furnace was 1.2, and clearance of the outer diameter of the quartz glass cylinder and the inner diameter of the heating element was 20 mm.

Into the above-described tube for optical fiber was inserted a clad-attached core rod (outer diameter 45 mm) similarly prepared by the VAD method, a preform for optical fiber was produced by a rod-in-tube method, and when the preform was wire-drawn into a single-mode optical fiber of 125 μm, the clad ellipticity was 0.80 μm. The above-described clad ellipticity is commonly used as a standard showing the ellipticity of an optical fiber and a single-mode optical fiber having the clad ellipticity of 1% or lower is the standardized article thereof.

### Comparative Example 1

Using a quartz glass cylinder of an outer diameter 150 mm, an inner diameter of 50 mm and a length of 3500 mm, the cylinder was stretched to a tube of an outer diameter of 60 mm by the resistance furnace as in Example 1. The OV of the tube obtained was 0.4 mm and the ellipticity was (0.4/60)×100=0.67%. In this case, the ratio (d/D) of the outer diameter D of the quartz glass cylinder and the inner diameter d of the heating furnace was 1.6, and the clearance was 45 mm.

When using the above-described tube, optical fibers were prepared as in Example 1, the clad ellipticity was 1.50 μm, which did not satisfy the general standard.

### EFFECT OF THE INVENTION

In the production method of the invention, a large quartz glass preform for optical fibers having a small ellipticity can be produced at a low cost, and by using the preform, a preform for optical fibers was prepared and by wire-drawing the preform for optical fibers, an optical fiber of a good quality having a small clad ellipticity can be produced with a good productivity at a low cost. Thus, the industrial value of the present invention is high.

### DESCRIPTION OF THE REFERENCE NUMBERS AND SIGNS

1: Apparatus for supplying inert gas

2: Heating furnace

3: Heating element

4: Quartz glass cylinder

5: Quartz glass tube

D: Outer diameter of quartz glass cylinder

ID: Inner diameter of quartz glass cylinder

d: Inner diameter of heating furnace

1. A method for producing a quartz glass preform for optical fibers by heating and stretching a quartz glass cylinder having an outer diameter (D) using a heating furnace having an upper part and a lower part and being equipped with a carbon-made heating element with an inner diameter (d), characterized by setting the ratio (d/D) to the range of from 1.02 to 1.5, and blowing in an inert gas from the upper part of the heating furnace into the heating element.

2. A method according to claim 1, wherein the ratio (d/D) is set to the range of from 1.1 to 1.3.

3. A method according to claim 1, wherein the outer diameter (D) of the quartz glass cylinder is at least 190 mm.

4. A method according to claim 1, wherein the clearance between the heating element and the quartz glass cylinder is established to be from 15 to 25 mm.

5. A method according to claim 1, wherein the ratio (D/ID) of the outer diameter (D) to the inner diameter (ID) of the quartz glass cylinder is set to from 2 to 5.

6. A method according to claim 1, wherein the quartz glass cylinder is a hollow cylinder comprising a core rod which is co-axially inserted in said hollow cylinder without being integrated with it.

7. A method according to claim 6, wherein the ratio (D/ID) of the outer diameter (D) to the inner diameter (ID) of the quartz glass hollow cylinder is set to from less than 2 to 5.

8. A method according to claim 1, wherein the heating furnace is a resistance furnace or an induction furnace.

9. A method for producing a quartz glass preform for optical fibers, said method comprising:
heating and stretching a quartz glass cylinder having an outer diameter using a heating furnace having an upper part and a lower part and being equipped with a carbon-made heating element with an inner diameter, the cylinder and the heating element being of dimensions such that a ratio of the inner diameter of said heating element to the outer diameter of said cylinder being in the range of from 1.02 to 1.5, and
blowing in an inert gas from the upper part of the heating furnace into the heating element.

10. A method according to claim 9, wherein the ratio 9 is in the range of from 1.1 to 1.3.

11. A method according to claim 9, wherein the outer diameter of the quartz glass cylinder is at least 190 mm.

12. A method according to claim 9, wherein the heating element and the quartz glass cylinder define a clearance space of from 15 to 25 mm therebetween.

13. A method according to claim 9, wherein the quartz glass cylinder has an inner diameter such that the ratio of the outer diameter to the inner diameter of the quartz glass cylinder is from 2 to 5.

14. A method according to claim 9, wherein the quartz glass cylinder comprises a hollow cylinder with an inner diameter, and a core rod is co-axially inserted in said hollow cylinder without being integrated therewith.

15. A method according to claim 14, wherein the ratio of the outer diameter to the inner diameter of the quartz glass hollow cylinder is from 2 to 5.

16. A method according to claim 9, wherein the heating furnace is a resistance furnace or an induction furnace.
